(19) United States
(12) Patent Application Publication
(10) Pub. No.: US 2022/0118302 A1
(43) Pub. Date: Apr. 21, 2022

(54) THERAPEUTIC OR EXERCISE BANDS AND CABLES SPECIALLY FORMULATED TO REDUCE TRANSMISSION OF HARMFUL VIRUSES, BACTERIA AND MICROBIAL PATHOGENS

(71) Applicant: DEPCO, INC., Hauppauge, NY (US)

(72) Inventors: M. Gregory Minuto, Smithtown, NY (US); Stephen Mlcoch, Manorville, NY (US)

(21) Appl. No.: 17/404,655

(22) Filed: Aug. 17, 2021

Related U.S. Application Data
(60) Provisional application No. 63/092,600, filed on Oct. 16, 2020.

(51) Int. Cl. A63B 21/055; A01N 59/20

(52) U.S. Cl. CPC A63B 21/0552; A63B 2209/00; A01N 59/20

(57) ABSTRACT

A therapeutic or exercise band or cable includes a latex, non-latex thermoplastic elastomer (TPE) or fabric serving as the base ingredient or component and copper sulfate, zinc sulfate, copper oxide, zinc oxide or zinc omadine® as a secondary ingredient mixed with the base band or cable materials or in combination with an antistatic ingredient. The inclusion of any one of the aforementioned secondary ingredients or the antistatic ingredient will reduce the risk of transmission of or infection from viruses, bacteria and microbial pathogens in or on the surfaces of the constructed band or cable when the band or cable is used for rehabilitation by patients or exercise by the general public.

### CROSS-REFERENCE TO RELATED APPLICATIONS

This application is related to U.S. Provisional Application Ser. No. 63/092,600, filed on Oct. 16, 2020, titled “Therapeutic Or Exercise Bands And Cables Specially Formulated To Reduce Transmission Of Harmful Viruses, Bacteria And Microbial Pathogens”, the disclosure of which is incorporated herein by reference and on which priority is hereby claimed.

### BACKGROUND OF THE INVENTION

### Field of the Invention

The present invention relates to therapeutic or exercise bands and cables specially made for use by the public seeking resistive type exercise methods or patients who have strength issues or require rehabilitation.

### Description of the Related Art

The general public may seek alternative exercise methods to free weights or exercise machines that offer suitable strength building and exercise by simpler use of resistive bands and cables. Also, many orthopedic and physical therapists treat patients who have various maladies. These maladies cover a wide range of issues from people who have strength issues to those who have issues with arthritis or recovery needs from an injury. Much of the rehabilitation is done through exercise. One of the ways exercise is done is with therapeutic exercise bands and cables that offer strength building and rehabilitation options.

One issue, which is part of current times of 2020, is the concern of the spread of viruses, unhealthy bacteria and microbial pathogens due to interaction and contact with other people, shared products and used materials. In rehabilitation environments, this concern is greater than ever before, especially for people that are not perfectly healthy or wish to remain healthy during exercise or rehab at home or in public environments. Removing risks associated with the need for people to have rehabilitation and exercise activities is an essential objective in treating patients in order to attain good health or the public that wish to sustain good health.

### OBJECTS AND SUMMARY OF THE INVENTION

It is an object of the present invention to provide a therapeutic or exercise band and cable which helps resolve the problem and concern of any exposure to viruses, bacteria and microbial pathogens during rehabilitation and exercise using an exercise band or cable.

The invention is directed to a therapeutic or exercise band and cable, which is manipulated in different ways by the user. It can be pulled, held in place and slowly released to sustain resistance by a person or by a patient and which includes a band or cable fabrication formulation, such as a latex, non-latex thermoplastic elastomer (TPE) or fabric resistive material and one of the antimicrobial ingredients disclosed herein or equivalents thereof added to and mixed with the band or cable fabricated formulation that will act to alleviate contact and exposure to undesired viruses, bacteria and microbial pathogens when the public or a patient is undergoing therapeutic or performing strength building exercises.

These and other objects, features and advantages of the present invention will be apparent from the following detailed description of illustrative embodiments thereof.

### BRIEF DESCRIPTION OF THE DRAWINGS

FIG. 1 is a perspective view of a therapeutic or exercise band or cable constructed in accordance with a first embodiment of the present invention.

FIG. 2 is a perspective view of a therapeutic or exercise band or cable constructed in accordance with a second embodiment of the present invention.

### DETAILED DESCRIPTION OF THE PREFERRED EMBODIMENTS

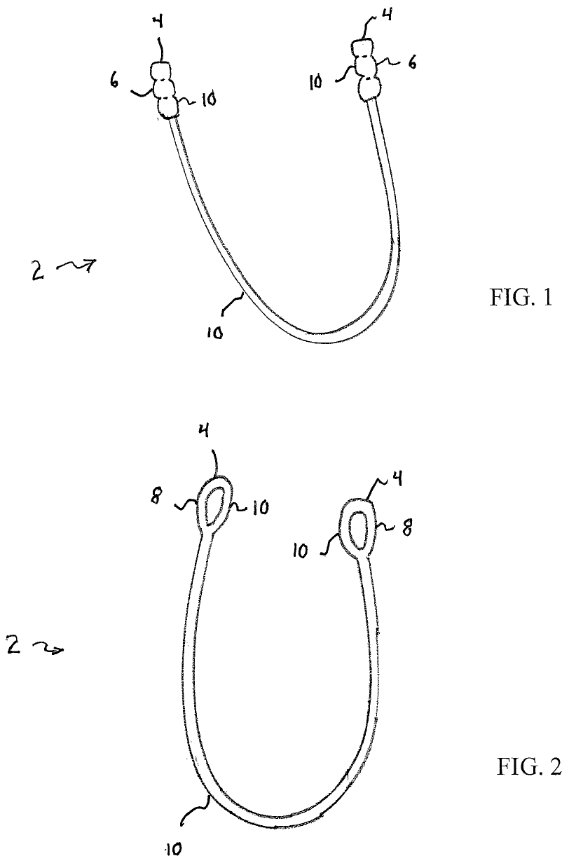

The invention is directed to a therapeutic or exercise band or cable 2, such as shown in FIGS. 1 and 2 of the drawings, in which copper sulfate, zinc sulfate, copper oxide, zinc oxide or zinc omadine® is added to the mix of the latex or non-latex batches or fabric, which is preferably a stretch composition material, from which the exercise band 2, having mechanically resistive and/or elastic properties, is formed. This mixing step of the ingredient is performed before the sheeting fabrication of the band or cable 2 so it is present throughout the final construction. The inclusion of any one of these ingredients will eradicate or at least reduce viruses, bacteria and microbial pathogens from the band or cable 2 in order to permit proper safe rehabilitation and exercise by users. These ingredients inherently have antimicrobial properties. These ingredients can kill bacteria, fungi and pathogens as well as eliminating viruses due to the copper and zinc components combined with the sulfur or as an oxide. The copper or zinc binds with the proteins associated with these microbials and kills bacteria and eradicates viruses by the disruption caused by this contact. This invention permits safe use in any user environment, long term storage between use or treatments and eliminates exposure risks during multiple use by others of the same band or cable 2 device during the lifetime or the product.

The therapeutic exercise band or cable 2 of the present invention is much like the devices and products available that produce a resistive characteristic that permits stretching and retraction like a rubber band. The ends 4 of the band or cable 2 preferably have a handgrip 6 (see FIG. 1) or loop 8 (see FIG. 2) suitable to hold or place a foot into or attach to a fixed area safely in order to perform the manipulation exercise, or may simply be an elongated length of latex, non-latex elastomer or fabric material, the material being solid or hollow (like tubing) without handgrips 6 or loops 8, and incorporating the antimicrobial ingredient during the formation thereof. The latex, non-latex elastomer and fabric type bands and cables 2 are made with varying tension levels so that many exercises can be done for lower body, upper body, leg, arm or abdominal focus. The latex, non-latex elastomer and fabric bands and cables 2 may vary in size, tension and resistive capability. Generally, these products can be washed or cleaned during irregular schedules but will resist viruses, bacteria and microbial pathogens when mixed with any one of the ingredients disclosed herein or equivalents thereof during all uses without dependence on washing or cleaning before repeat use.

Another agent ingredient that may be added to the latex or non-latex mix or fabric with or without the antimicrobials disclosed herein is an antistatic ingredient, or an “antistat”, as is commonly known, such as Dow Corning 1-6136 Antistat (a cationic alkoxy silane which is designated as 3-trimethoxysilylpropyloctadecyidimethyl ammonium chloride). This ingredient having an anti-static characteristic contributes to further safe use and helps to reduce virus exposure to exercise band or cable users. Certain viruses need an electrostatic charge to be present in order to adhere to materials before it can attach to living cells. This characteristic of the 1-6136 Antistat product and other antistats prevents or reduces the ability of viruses and microbes to stick or adhere to the band and cable surfaces 10.

Inclusion of the antimicrobial ingredients disclosed herein, when individually part of the band or cable material mixture, helps in the eradication, elimination or reduction of exposure to harmful viruses, bacteria and microbial pathogens. Exposure risks to users from use of the therapeutic and exercise bands and cables 2 of the present invention are eliminated or at least minimized.

The preferred formulations for such a therapeutic exercise band and cable 2, containing the antimicrobial ingredients disclosed herein or equivalents thereof, can be the latex, non-latex thermoplastic (TPE) elastomer or fabric component mixed with copper sulfate, zinc sulfate, copper oxide, zinc oxide or zinc omadine® (zinc 2-pyridinethiol-1-oxide, also referred to as zinc pyrithione) in a preferred amount of the mixture from about 0.1% to about 5% of the total formula. The inclusion of the Dow Corning 1-6136 Antistat ingredient or other antistat into the mixture with copper sulfate, zinc sulfate, copper oxide, zinc oxide or zinc omadine® provides further user protection based on the antistatic characteristic of this ingredient. The preferred amount of this 1-6136 Antistat ingredient or other antistat can be from about 0.1% to about 5% of the new mixture or it can be added alone with the latex, non-latex thermoplastic elastomer (TPE) or fabric band or cable by the same percentage of total weight mentioned above. More specifically, the preferred prophetic formulations for the therapeutic exercise band or cable 2 of the present invention are as follows:

About 0.1% (percentage of total weight) copper sulfate, zinc sulfate, copper oxide, zinc oxide or zinc omadine® or another ingredient which kills, or prevents or inhibits the growth of, bacteria and microbes and eradicates or reduces the concentration of viruses in the band or cable 2, plus about 99.9% (percentage of total weight) of the latex, non-latex thermoplastic elastomer (TPE) or fabric component; to about 5% (percentage of total weight) copper sulfate, zinc sulfate, copper oxide, zinc oxide or zinc omadine® or another ingredient which kills, or prevents or inhibits the growth of, bacteria and microbes and eradicates or reduces the concentration of viruses in the band or cable 2, plus about 95% (percentage of total weight) of the latex, non-latex thermoplastic elastomer (TPE) or fabric component; or

About 0.1% (percentage of total weight) Antistat 1-6136 agent or another ingredient which reduces the electrostatic attraction of viruses and microbes to the surfaces 10 of the band or cable 2, plus about 99.9% (percentage of total weight) of the latex, non-latex thermoplastic elastomer (TPE) or fabric component; to about 5% (percentage of total weight) Antistat 1-6136 agent or another ingredient which reduces the electrostatic attraction of viruses and microbes to the surfaces 10 of the band or cable 2, plus about 95% (percentage of total weight) of the latex, non-latex thermoplastic elastomer (TPE) or fabric component; or

About 0.1% (percentage of total weight) copper sulfate, zinc sulfate, copper oxide, zinc oxide or zinc omadine® or another ingredient which kills, or prevents or inhibits the growth of, bacteria and microbes and eradicates or reduces the concentration of viruses in the band or cable 2, and about 0.1% (percentage of total weight) Antistat 1-6136 agent or another ingredient which reduces the electrostatic attraction of viruses or microbes to the surfaces 10 of the band or cable 2, plus about 99.8% (percentage of total weight) of the latex, non-latex thermoplastic elastomer (TPE) or fabric component; to about 5% (percentage of total weight) copper sulfate, zinc sulfate, copper oxide, zinc oxide or zinc omadine® or another ingredient which kills, or prevents or inhibits the growth of, bacteria and microbes and eradicates or reduces the concentration of viruses in the band or cable 2 and about 5% (percentage of total weight) Antistat 1-6136 agent or another ingredient which reduces the electrostatic attraction of viruses and microbes to the surfaces 10 of the band or cable 2, plus about 90% (percentage of total weight) of the latex, non-latex thermoplastic elastomer (TPE) or fabric component.

Other secondary ingredients (dyes, fabric stitching, etc.) may be added to the therapeutic bands and cables 2 that may reduce the approximate percentages in total weight of the latex, non-latex thermoplastic elastomer (TPE) or fabric component in the prophetic formulations mentioned above, as long as the percentage of the ingredient which kills, or prevents or inhibits the growth of, bacteria and microbes and eradicates or reduces the concentration of viruses in the band or cable 2 is in the range of about 0.1% of the total weight of the therapeutic exercise band or cable product and about 5% of the total weight of the therapeutic exercise band or cable product, and as long as the percentage of the ingredient which reduces the electrostatic attraction of viruses and microbes to the surfaces 10 of the band or cable 2 is in the range of about 0.1% of the total weight of the therapeutic exercise band or cable product and about 5% of the total weight of the therapeutic exercise band or cable product, each of the ingredients mentioned above (i.e., the ingredient which kills, or prevents or inhibits the growth of, bacteria and microbes and eradicates or reduces the concentration of viruses in the band or cable 2 and the ingredient which reduces the electrostatic attraction of viruses and microbes to the surfaces 10 of the band or cable 2) being included alone or in combination with the other ingredient in the therapeutic band and cable product of the present invention.

Examples of how the exercise band or cable 2 of the present invention, having antimicrobial and/or antistatic properties, is preferably formed are set forth below:

Latex is a polymer in a water-based liquid or viscous state and is a form of rubber. A wet slurry state permits the antimicrobial ingredient preferably in a powder form and/or an antistatic ingredient (also preferably in a powder form) to be mixed into the latex. The mixture can be put into a mold or subjected to an extruding process to form the band or cable 2. When the water evaporates or the mixture dries, the solid formed device 2 remains.

Heat can be used to speed the formation process to evaporate the water and dry the mixture. Temperature up to about 212 F degrees is used for a suitable duration according to the volume of the mixture.

Natural rubber latex is in a milky fluid form that consists of extremely small particles of rubber. An antimicrobial ingredient and/or an antistatic ingredient is mixed into this fluid material to create bands or cables 2 by dipping, extruding, or coating according to a natural rubber (latex) process. A dry rubber latex process involves the use of coagulated latex in a dried or milled sheet form. The antimicrobial ingredient and/or the antistatic ingredient is added during this process by simple mixing. The cables and bands 2 are formed by compression molding, extrusion or by converting the sheets into a solution for dipping. A conversion method of prefabricated sheets into a solution permits inclusion of the antimicrobial ingredient and/or the antistatic ingredient before the product formation.

When the natural rubber latex is in a bail form, which is dry, it is mixed in a sigma arm mixer and filler is added. Catalysts including sulfur and pigments are added. This mixture can be heated while being extruded into sheet stock or in a tube and then sliced.

Non-latex TPE is used in a similar or equivalent process. The antimicrobial ingredient and/or the antistatic ingredient can be added to the formula in a dry or wet form by mixing. The cables and bands 2 can be created from this material. Stretch fabric bands, functioning like rubber bands, can be made from latex or non-latex materials that have included an antimicrobial ingredient and/or an antistatic ingredient as described above before the finish part is made and then formed with the fabric by a dipping method to permanently coat the stretch fabric band. The antimicrobial ingredient and/or the antistatic ingredient becomes integral to the finished band 2 by this method.

Tests were performed to determine the efficacy of adding an antimicrobial ingredient to a latex base used in making an exercise band or cable 2 formed in accordance with the present invention. A latex formula sample made with two percent (2%) by weight of zinc omadine® (98% latex by weight) was tested, and the results of such tests show over a ninety-nine percent (99%) effectiveness of the zinc/latex mixture in reducing the presence of microbials.

More specifically, an independent laboratory was engaged to study the antibacterial efficacy of a latex mixture having two percent (2%) by weight of zinc omadine®. The tests were performed in accordance with ISO 22196:2011 standard, and the challenge organism was Methicillin-resistant Staphylococcus aureus, ATCC 43300. The antimicrobial ingredient (zinc omadine®) was mixed into the latex base during sample fabrication and evenly dispersed during mixing the ingredient into the latex formula.

A summary of the test methodology is as follows:

A suspension of the test bacteria (methicillin-resistant S. aureus) was prepared in 1:500 nutrient broth and adjusted to yield approximately 10⁶-10⁷ cfu/mL. The samples provided by the applicant herein (both test and control) were placed in sterile petri dishes, inoculated in triplicate with 200 μL of the previously prepared bacterial suspensions, and overlaid with sterile polyethylene cover films. Baseline readings were conducted to determine the exact starting organism concentration by adding 10 mL of Dey-Engley neutralizing broth to three control samples. The samples were mixed well, serially diluted in phosphate buffered saline (PBS), and plated in duplicate on trypticase soy agar (TSA). Test and control coupons were processed in an identical fashion after 24 hours, and all plates incubated at 35° C. for 24-48 hours. After incubation, all plates were counted, and the percent and log differences calculated.

The tests performed by the independent laboratory showed that the efficacy of an antimicrobial ingredient (in this case, zinc omadine®) mixed in the latex sample was found to be significant when compared to an untreated latex control sample in reducing by 99.74% levels of challenge microorganism Staphylococcus aureus from inoculum challenge levels at 24 hours post-inoculum. It should be noted that the efficacy of the untreated latex control sample was also significant in reducing by 99.04% levels of the challenge microorganism, indicating the product itself without the added zinc omadine® may have inherent antimicrobial properties.

The therapeutic exercise band and cable 2 of the present invention, such as disclosed in the above formulations, will aid in preventing contact, exposure or the spread of viruses, bacteria and microbial pathogens from a user during normal repeated use at any environment or for a patient or therapist to the band or cable 2 and/or from the band or cable surfaces 10 to the user, patient or therapist when human contact to the human body skin begins, sustained during rehabilitation exercise or from reuse after storage. The band or cable mixture formulation of the present invention eradicates, eliminates or at least reduces potential exposure risks present in the environment when the therapeutic exercise band or cable 2 of the present invention is used by the public, including a rehab patient, home exercise enthusiast and dedicated public gym visitor.

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. A therapeutic or exercise band, which comprises:
an elongated member having mechanically resistive and/or elastic properties, the elongated member being formed from a base component; and
an antimicrobial ingredient mixed with the base component.

2. A therapeutic or exercise band as defined by claim 1, wherein the base component is formed from one of a latex ingredient, a non-latex thermoplastic elastomer and a fabric resistive material.

3. A therapeutic or exercise band as defined by claim 2, wherein the antimicrobial ingredient is selected from the group consisting of copper sulfate, zinc sulfate, copper oxide, zinc oxide, zinc omadine®, zinc pyrithione and zinc 2-pyridinethiol-1-oxide.

4. A therapeutic or exercise band as defined by claim 3, wherein the antimicrobial ingredient is in the range of about 0.1% (percentage of total weight) to about 5% (percentage of total weight); and
wherein the base component is in the range of about 99.9% (percentage of total weight) to about 95% (percentage of total weight).

5. A therapeutic or exercise band as defined by claim 3, which further comprises:
an antistatic ingredient mixed with the base component;
wherein the antimicrobial ingredient is in the range of about 0.1% (percentage of total weight) to about 5% (percentage of total weight);
wherein the antistatic ingredient is in the range of about 0.1% (percentage of total weight) to about 5% (percentage of total weight); and
wherein the base component is in the range of about 99.8% (percentage of total weight) to about 90% (percentage of total weight).

6. A therapeutic or exercise band as defined by claim 5, wherein the antistatic ingredient is a cationic alkoxy silane.

7. A therapeutic or exercise band as defined by claim 5, wherein the antistatic ingredient is 3-trimethoxysilylpropyloctadecyidimethyl ammonium chloride.

8. A therapeutic or exercise band as defined by claim 3, wherein the antimicrobial ingredient is zinc omadine® at about 2% (percentage of total weight); and
wherein the base component is a latex ingredient at about 98% (percentage of total weight).

9. A therapeutic or exercise band, which comprises:
an elongated member having mechanically resistive and/or elastic properties, the elongated member being formed from a base component; and
an antistatic ingredient mixed with the base component.

10. A therapeutic or exercise band as defined by claim 9, wherein the base component is formed from one of a latex ingredient, a non-latex thermoplastic elastomer and a fabric resistive material.

11. A therapeutic or exercise band as defined by claim 10, wherein the antistatic ingredient is a cationic alkoxy silane.

12. A therapeutic or exercise band as defined by claim 10, wherein the antistatic ingredient is 3-trimethoxysilylpropyloctadecyidimethyl ammonium chloride.

13. A therapeutic or exercise band as defined by claim 10, wherein the antistatic ingredient is in the range of about 0.1% (percentage of total weight) to about 5% (percentage of total weight); and
wherein the base component is in the range of about 99.9% (percentage of total weight) to about 95% (percentage of total weight).
